(19) United States
(12) Patent Application Publication
(10) Pub. No.: US 2007/0282784 A1
(43) Pub. Date: Dec. 6, 2007

(54) Comprehensive algebraic relationship discovery in databases

(76) Inventors: Natwar Modani, New Delhi (IN); Harald Clyde Smith, Groveland, MA (US)

Correspondence Address: MH2 TECHNOLOGY LAW GROUP, 1951 KIDWELL DRIVE, SUITE 550, TYSONS CORNER, VA, 22182, US

(21) Appl. No.: 11/443,084

(22) Filed: May 31, 2006

(51) Int. Cl. G06F 17/30

(52) U.S. Cl. 707/1

(57) ABSTRACT

The present invention provides methods and systems for discovering and determining algebraic relationships between sets of data, such as numeric columns in a relational database, based on a “bottom-up” (or data-driven) approach. Embodiments of the present invention provide for the discovery and determination of algebraic relationships within a single relation or algebraic relationships across multiple tables that can be joined via a foreign key relationship. The foreign key relation can be one-to-one, many-to-one, or one-to-many. In order to discover algebraic relations, mean, variance and correlations calculations between columns are performed, for example, based on taking samples of the columns. Irreducible relations are then determined. Samples are taken from the irreducible relations and algebraic relationships between columns are determined based on various calculation techniques and correlations between the columns.

### FIELD

The present invention relates to database management systems. In particular, the present invention relates to discovering and determining relationships between sets of data in databases.

### BACKGROUND

Organizations have increasingly sought to identify business rules for their data and then assessing the compliance of the data to those business rules. For example, an organization may calculate currency conversions, require that a delivery date should occur within 1 to 15 days of the shipping date, or require that total quantity of product must equal quantity shipped plus quantity remaining in inventory. Organizations may then use these business rules to control and monitor their business processes.

Unfortunately, in many real-world environments, it is difficult to discover or determine the relationships between data of an organization. With mergers and consolidations of organizations in the expanding lines of data across disparate systems, the effort to identify such business rules and put in place queries to measure data quality or compliance to those rules is high and likely be incomplete.

Known techniques provide a method to identify the existence of correlations or relations between numeric database columns. However, these techniques are very limited and often fail to discover the majority of relationships that are of interest to users. For example, the known techniques may be able to determine a correlation between columns of a database, but fail to determine the underlying algebraic relationship between columns. In addition, the known techniques typically require extensive processing or may take large amounts of time.

Accordingly, it may be desirable to provide methods and systems that can discover and determine a variety of classes of relationships between data. In addition, it may be desirable to provide methods and systems that can discover and determine relations that is fast and efficient regardless of the amount of data.

### SUMMARY

In accordance with one feature of the invention, a method is provided for determining an algebraic relationship between columns of two or more relations. Primary keys and foreign keys in the relations are identified. Irreducible relations are determined from the relations based on the primary and foreign keys. Rows of the irreducible relations are sampled and correlations between columns from the sample rows of the irreducible relations are calculated. Algebraic relationships between the columns are then determined based on the correlations.

In accordance with another feature of the invention, a method is provided for determining an algebraic relationship between columns of two or more relations, said method comprising: Primary keys and foreign keys in the relations are identified. Irreducible relations are determined from the relations based on the primary and foreign keys. Rows of the irreducible relations are sampled. Aggregation relations between the relations are then determined based on the sampled rows of the irreducible relations.

In accordance with another feature of the invention, a server is configured to determine relationships between columns of two or more relations. The server comprises a processor and a memory. The memory is coupled to the processor and stores executable program code for identifying primary keys in the relations, identifying foreign keys in the relations, determining irreducible relations from the relations based on the primary and foreign keys, sampling rows of the irreducible relations, calculating correlations between columns from the sample rows of the irreducible relations, and determining at least one of algebraic relationships and aggregation relationships between the columns based on the correlations.

Additional features of the invention will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 shows a system that is consistent with the principles of the present invention;

FIG. 2 shows a diagram of exemplary hardware components for an information server shown in FIG. 1 that is consistent with the principles of the present invention.

FIG. 3 shows an exemplary process flow for determining an algebraic relationship between columns of two or more relations; and

FIG. 4 shows another exemplary process flow for determining an algebraic relationship between columns of two or more relations.

### DESCRIPTION OF THE EMBODIMENTS

The present invention provides methods and systems for discovering and determining algebraic relationships between sets of data, such as numeric columns in a relational database, based on a “bottom-up” (or data-driven) approach. The term algebraic relationships is intended to broadly refer to any relationship or system of relationships that follow a set of formal rules, such as mathematical rules, finite processes, etc. Some embodiments of the present invention provide for the discovery and determination of algebraic relationships within a single relation or algebraic relationships across multiple tables that can be joined via a foreign key relationship. The foreign key relation can be one-to-one, many-to-one, or one-to-many. In order to discover algebraic relations, mean, variance and correlations calculations between columns are performed, for example, based on taking samples of the columns. In general, primary and foreign keys are provided or found by analyzing the database. Irreducible relations are then determined. Samples are taken from the irreducible relations and algebraic relationships between columns are determined based on various calculation techniques and correlations between the columns.

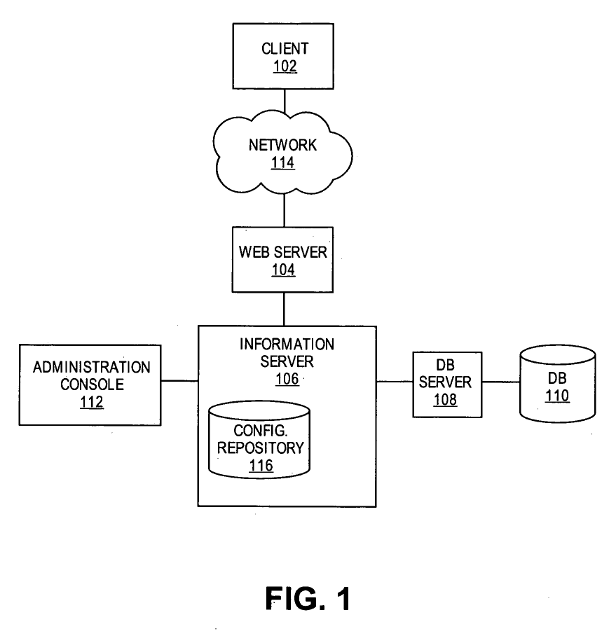

Reference will now be made in detail to exemplary embodiments of the invention, which are illustrated in the accompanying drawings. Wherever possible, the same reference numbers will be used throughout the drawings to refer to the same or like parts. The present disclosure begins by providing an exemplary system and describing some of its components. One skilled in the art will recognize that various database architectures may be implemented, such as relational databases and object oriented databases. For purposes of illustration, embodiments of the present invention are provided for use on a relational database system. The present disclosure now begins with reference to FIG. 1.

FIG. 1 shows a system 100 that is consistent with the principles of the present invention. For purposes of illustration, system 100 is configured as a system. As shown, system 100 may comprise a client 102, a web server 104, an information server 106, a database server 108, an application database 1 10, and an administration console 112.

These components may be coupled together using one or more networks 114, such as a local area network, or wide area network. In addition, these components may communicate with each other using known protocols, such as the transport control protocol and internet protocol (“TCP/IP”) and hypertext transport protocol (“HTTP”).

The components of system 100 may be implemented on separate devices or may be implemented on one or more of the same devices or systems. System 100 may be implemented on multiple devices for reliability or scalability purposes. For example, web server 102, information server 106, and database server 108 may be installed on the same machine and run under a common operating system. Alternatively, system 100 may have one or more of its components implemented on multiple machines that run different operating systems. Some of the specific components of system 100 shown in FIG. 1 will now be described in turn.

Client 102 provides a user interface for system 100. Client 102 may be implemented using a variety of devices and software. For example, client 102 may be implemented on a personal computer, workstation, or terminal. In addition, client 102 may run under a Windows operating system, or through a browser application, such as Internet Explorer by Microsoft Corporation or Netscape Navigator by Netscape Communications Corporation. One skilled in the art will recognize that these browsers commonly support HTTP communications. Although FIG. 1 shows a single client, system 100 may include any number of clients.

Web server 104 provides communication services between client 102, information server 106, and database server 108. In one embodiment, web server 104 is implemented as a web server that provides various HTTP services. In particular, web server 1₀₄ may accept page requests from browsers running on client 102 and return web pages via the HTTP protocol. Web server 104 may also support other services, such as Java servlets and Java Server Pages.

Information server 106 provides an environment for implementing the present invention. For example, information server 106 may comprise a runtime environment, such as a Java runtime environment, that performs the processes for discovering and determining algebraic relationships in application database 110.

As shown in FIG. 1, in some embodiments, web server 104 may include a configuration repository 116. Configuration repository 116 is a collection of configuration files that contain the configuration information for information server 106. In some embodiments, these configuration files are in the form of an XML file and indicate which requests are handled by information server 106. This configuration file may be generated and provided by administration console 112 as applications supported by information server 106 are deployed on client 102. Of course, information server 106 may comprise multiple configuration repositories to support multiple environments and runtime environments in information server 106.

Information server 106 may also comprise various components (not shown) for communicating with web server 104. For example, information server 106 may comprise an embedded HTTP server that receives requests from web server 104 and passes them to the other components of information server 106 for processing. In some embodiments, information server 106 may support both HTTP and secure HTTP (“HTTPS”).

Database server 108 manages the operations for accessing and maintaining application database 110. For example, database server 108 may be implemented based on well known portal products, such as those provided by International Business Machines. Database server 108 may support a wide variety of databases, such as DB2, Informix, Oracle, SQL Server, Sybase, and the like.

Application database 110 comprises the components for storing the application data of interest to system 100. Application database 110 may be implemented using a variety devices and software. As noted, for purposes of illustration, application database 110 is explained based on being implemented as a relational database, such as a DB2 Universal database. In addition, application database 110 may use a variety of types of storage, such as can drive optical storage units, or magnetic disk drive.

Administration console 112 provides an administrative interface for system 100. In particular, one or more administrators of system 100 may utilize administration console 112 to configure to the operations of system 100. Administration console 112 may be implemented using a variety of devices and software. For example, administration console 112 may be implemented on a personal computer, workstation, or terminal. In addition, administration console 112 may run under a Windows operating system, or through a browser application, such as Internet Explorer by Microsoft Corporation or Netscape Navigator by Netscape Communications Corporation. In the embodiment shown, administration console 112 may run through a browser, such as Internet Explorer or Netscape Navigator that communicates with information server 106 using HTTP, HTTPs, and the like. Although FIG. 1 shows a single console, system 100 may include any number of administration consoles.

In some embodiments, administration console 112 is implemented as a web-based interface provided from information server 106. Thus, an administrator may use administration console 112 to configure information server 106. For example, as noted above, administration console 112 may interface an embedded HTTP server (not shown) of information server 106 in order to read the configuration files from configuration repository 116 and permit an administrator to set the configuration of information server 106.

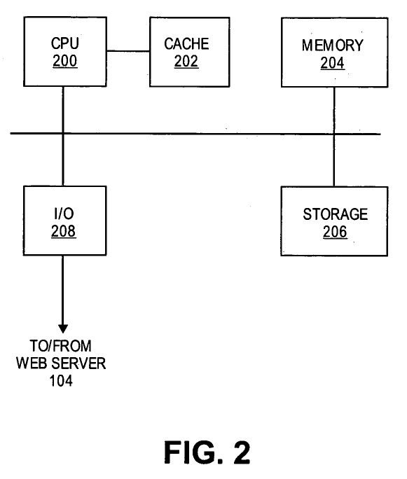

FIG. 2 shows a diagram of exemplary hardware components in information server 106 that is consistent with the principles of the present invention. As shown, information server 106 may include a central processor 200, a cache 202, a main memory 204, a local storage device 206, and an input/output controller 208. These components may be implemented based on hardware and software that is well known to those skilled in the art.

Processor 200 may include cache 202 for storing frequently accessed information. Cache 202 may be an “on-chip” cache or external cache. Information server 106 may also be provided with additional peripheral devices, such as a keyboard, mouse, or printer (not shown). In the embodiment shown, the various components of information server 106 communicate through a system bus or similar architecture.

Although FIG. 2 illustrates one example of the structure of information server 106, the principles of the present invention are applicable to other types of devices and systems. That is, information server 106 may be implemented on a device having multiple processors, or may comprise multiple computers (or nodes) that are linked together.

Operating system (OS) 210 may be installed in memory 204, for example from local storage 206, and is an integrated collection of routines that service the sequencing and processing performed by information server 106. OS 210 may provide many services for server 104, such as resource allocation, scheduling, input/output control, and data management. OS 210 may be predominantly software, but may also comprise partial or complete hardware implementations and firmware. Well-known examples of operating systems that are consistent with the principles of the present invention include the z/OS operating system, LINUX, and UNIX.

The above description merely provides an exemplary description of some embodiments of the present invention. One skilled in the art will recognize that embodiments of the present invention can be implemented in other environments and architectures. However, description of some embodiments of the present invention will now continue in reference to application to a relational database. Accordingly, the present disclosure will make reference to a relational database that comprises one or more relations (or tables) having a row/column format. As is well known to those skilled in the art, relations may comprise a primary key that uniquely identifies each record (or row) in that relation. When manipulating multiple relations, a relation may have foreign key, which is a column (or field) that matches the primary key column of another relation.

Now that some exemplary systems have been described, the present disclosure will now describe various processes and methods that are consistent with the principles of the present invention. Unlike the known techniques that merely identify correlations (which are simply a measure of the degree of relatedness) between columns, embodiments of the present invention can be used to efficiently discover and determine algebraic relationships between columns in one or more relations. Besides handling much more general class of relations and going beyond the discovery of mere correlation, embodiments of the present invention can provide fast and scalable performance, both in terms of number of candidate columns as well as the table sizes containing the columns.

In general, embodiments of the present invention the set of relations that may be discovered are quite comprehensive. The present invention is capable of discovering all the possible two column relations and a significant set of relations involving three columns. For purpose of explanation, the processing for three classes, class 1, 2, and 3, of algebraic relations are described. For each class, let X, Y, and Z be three numeric columns of relations in application database 110 and let D be a categorical column. A categorical column may be any column that can take one of a predefined set of values, such as a numeric or a string of alpha-numeric characters.

Class 1 relations refer to relations between two or more columns. In this class, X, Y, and Z can be columns from the same relation or relations related by a one-to-one or many-to-one mapping. The following algebraic relationships may be discovered and determined:

m1*X⊕m2*Y=K, where ⊕ is + or −, and m1, m2 and K are constants; m1*X ⊕m2*Y ⊕m3*Z=K, where ⊕ is + or −, and m1, m2, m3 and K are constants;

m1*X ⊕m2*Y=k, where ⊕ is + or − and k belongs to interval I, and m1 and m2 are constants;

if column D influences the relationship between two columns X and Y, then for each value of D, X and Y are related by a two column relation, with the parameters m1, m2 and K or k being dependent on the value of column D; and

if the relation is of ordering type, i.e., X≧Y (e.g., delivery date≧shipping date), then such relations may be found using the correlation between the columns in question.

Class 2 relations refer to relations between two or more columns. In this class, X, Y and Z are columns from the same relation or relations related by one-to-one or many-to-one mapping. In this class, such relations can be found using the correlation between the logarithms of values in the columns in question. In some embodiments, this may also require that values in the columns should be positive. The following algebraic relations may be sought:

X ⊙Y=K, where ⊙ is * or / and K is a constant;

X ⊙Y ⊙Z=K, where ⊙ is * or /, and K is a constant;

X ⊙Y=k, where ⊙ is * or /, and k belongs to interval I; and

if column D influences the relationship between two columns X and Y, then for each value of D, X and Y are related by a two column relation, with the parameter K or k being dependent on the value of column D.

For class 1 and 2 relations, mean, variance and correlations between column pairs may be used to quickly discover the algebraic relations. Since the estimate of quantities in these types of relations can be obtained with acceptable accuracy with fairly small samples sizes (e.g., 100-1000 samples), embodiments of the present invention can identify the candidate relations very quickly.

Class 3 relations refer to aggregation relations between two tables. For example, let R₁ and R₂ be two relations such that R₂ refers to R₁ and that many rows in R₂ refers to the same row in R1, via a foreign key (i.e., one-to-many relation from R₁ to R₂). The following algebraic relations may be sought:

column X in R₁ may be the sum of all rows for column Y in R₂, such that all these rows refer to the same row in R₁; and

a column X in R₁ may be a count of number of rows for column Y in R₂, such that all these rows refer to the same row in R₁.

In some embodiments, the well known BHUNT technique may be used in combination with the present invention to provide a method to identify relations between numeric database columns of the form X ▴ Y=k, where ▴ is +,−,*, or/ and k belongs to I₁ U I₂ U . . . U Iₙ, where Iⱼ is an interval. In one embodiment, the value of k is allowed in a single interval only (compared to BHUNT, which allows k to assume a value in a union of intervals). In addition, the BHUNT technique may be used to fine tune the interval definition.

The BHUNT technique is described, for example, in “BHUNT: Automatic discovery of fuzzy algebraic constraints in relational data,” by Peter J. Haas et al., 29^{th} VLDB Conference, which is herein incorporated by reference in its entirety. However, one skilled in the art will recognize that embodiments of the present invention are not limited to the capabilities of the BHUNT technique. Indeed, embodiments of the present invention can discover and determine a variety of types of relationships beyond what is possible by the BHUNT technique and the like.

In overview, for class 1 and 2 relations, the process generally entails: finding the primary and foreign keys; creating irreducible relations; sampling from the irreducible relations; calculating correlations; and determining the algebraic relations between various columns. For class 3 relations, embodiments of the present invention generally entail discovering aggregation types of relations, such as summation or ordering.

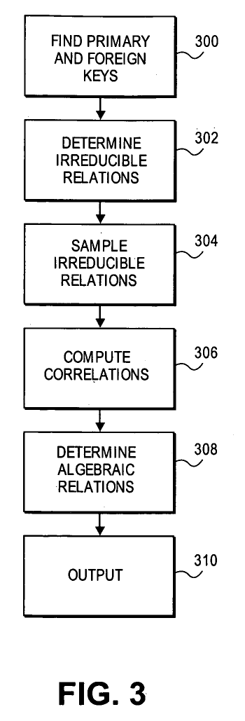

Referring now to FIG. 3, a process is illustrated for discovering and determining algebraic relationships. For purposes of explanation, FIG. 3 will now be described with reference to class 1 relations.

In stage 300, information server 106 finds the primary and foreign keys of the subject relations of application database 110. As an example, below is shown relations (tables) of class 1 that may be part of application database 110. One relation may be an order item relation, which has a primary key of “OrderItemNumber.”

| OrderItemNumber | SKU | Quantity | Amount |
|---|---|---|---|
| 1 | 1 | 4 | 100.00 |
| 2 | 2 | 3 | 60.00 |
| 3 | 2 | 5 | 100.00 |
| 4 | 3 | 3 | 90.00 |

Another relation may be a product information relation, such as the one shown, below.

| SKU | PerUnitPrice |
|---|---|
| 1 | 25.0 |
| 2 | 20.0 |
| 3 | 30.0 |

As can be seen, the product information relation has “SKU” as its primary key, which is also a foreign key in the order item relation, even though the SKU is not a unique key in the order item relation.

Information server 106 may determine the primary and foreign keys based on information provided to it, for example, from administration console 112 or configuration repository 116. Alternatively, information server 106 may automatically discover the primary and foreign keys in application database 110 based the following technique.

In particular, let Rᵢ, 1≦i≦r be the relations to be explored by information server 106. If the primary keys and foreign keys are known by the schema reliably, information server 106 may use them directly. Otherwise, information server 106 may attempt to discover these automatically. For each relation in the set to be examined, information server 106 may look for primary and unique keys. The primary key could be of any type. In some embodiments, however, information server 106 primarily explores primary keys that are only integer, long and small character fields as candidate primary key columns for efficiency reasons. Primary key candidate columns are the ones where the value is not null and are unique. This yields a set of unique/primary keys for each relation. Hence, let pi be the primary key for the relation Rᵢ.

Candidate foreign keys may also be of any type. However, again for purposes of efficiency, information server 106 may primarily consider candidate foreign keys in columns that are integers or long and small character fields. They may or may not be unique keys in their relation.

To find the foreign keys, information server 106 checks for a containment relation. For this, information server 106 takes each candidate foreign key column in turn and checks for all the unique keys for containment relations. Since this may be a costly operation, information server 106 may perform other processing to avoid this if possible. Hence information server 106 may first check that the number of unique values of the candidate column must be no more than the number of rows in the table which information server 106 may consider as candidate base table. Additionally, for numeric foreign key candidate columns, information server 106 may first check that the min (max) of candidate foreign key column is less (greater) than or equal to the min (max) of the candidate base table primary key. If not, the containment relation does not hold.

If yes, then information server 106 may check for containment relation (i.e., whether all the values in the first column are also present in the second column). If the containment relation holds, the column pair in question is a candidate for primary key-foreign key relation.

In stage 302, information server 106 determines an irreducible relation from the subject relations. For example, from above, the irreducible relation can be determined as a join performed on SKU between the two relations. Accordingly, the following irreducible relation may result.

| OrderItemNumber | SKU | Quantity | Amount | PerUnitPrice |
|---|---|---|---|---|
| 1 | 1 | 4 | 100.00 | 25.0 |
| 2 | 2 | 3 | 60.00 | 20.0 |
| 3 | 2 | 5 | 100.00 | 20.0 |
| 4 | 3 | 3 | 90.00 | 30.000 |

Information server 106 may determine irreducible relations based on the following technique. As noted above, let Rᵢ, 1≦i≦r be the relations to be explored, and let pᵢ be their primary keys respectively. If the kth column from the jth relation qₖⱼ refers to pᵢ and is itself a unique key for relation Rj, then information server 106 may merge the two relations Ri and Rj by a simple join via pᵢ. Information server 106 may then repeat this process until it is not possible to reduce the number of relations further. Thus, in this technique, information server 106, irreducible relations are those relations that can not be further reduced in the above given sense. This irreducible relation need not be physically created; they may just be a view.

In addition, after the irreducible relations are formed, information server 106 may drop the columns which are not numeric or categorical. The categorical columns are those which have a relatively small number of distinct values. However, the number of distinct values can be can be controlled by a (potentially a user or administrator) parameter from configuration repository 116. Some examples of categorical columns are country and state in an address, gender of a person, and the like.

In stage 304, information server 106 may sample the irreducible relations found in stage 302. In some embodiments, information server 106 may take a Bernoulli sample of the rows from the irreducible relations as identified above. Each row is included in the sample with probability p, where p can be chosen so as to ensure an adequate sample size with high confidence.

In stage 306, information server 106 may compute correlation and other statistics. For example, information server 106 may compute the following quantities for each column and column pair. The total for the columns Tₓ, T_{y}, the sums of square Σx, Σy, and the sum of the products P of the N pairs of values from columns X and Y.

For example, information server 106 may compute correlations based on:

A=Σx−T²ₓ/N,

B=Σy−T²ₓ/N, and

W=P−(Tₓ*T_{y})/N.

Accordingly, the correlation between columns X and Y is r W/√AB. This provides a matrix C of correlations, where cij indicates the correlation between column i and j.

In stage 308, information server 106 may then determine algebraic relations between columns. For example, information server 106 may scan the C matrix computed as above. In some embodiments, information server 106 may only need to look at the upper triangle part of the matrix excluding the diagonal, since the matrix is symmetric and all the diagonal entries are always 1. That is, if the entry cᵢⱼ is 1, then the two columns are related by an exact relation.

Let the ith and jth columns be xi and xj respectively, then m₁*xᵢ+m₂* xⱼ=K, for some m₁, m₂ and K, where all of these are some real constants. This may be called exact relations since the value of K is a constant (as opposed to belonging to an interval). Information server 106 may get the value of the constants by taking two rows from the sample and substituting the values of xᵢ and xⱼ, and taking m1=1, to obtain the values of m₂ and K.

Every time information server discovers such an algebraic relationship, it removes one of the database columns from the C matrices (i.e., removing the jth row and jth column of the C matrix). Information server 106 may perform this to ensure that it gets a smallest set of relations which are independent of each other.

Information server 106 may also search for various three column exact relations. In particular, information server 106 may scan the C matrix computed as above. Information server 106 may then compute the value of C²ᵢⱼ+C²ⱼₖ by scanning the ith row of the C matrix. If this quantity is between 1−ε(where ε is a small real number) and 2, then i, j and k columns are candidates for a three column relation. If 1−ε<C²ᵢⱼ+C²ᵢₖ<1+C²ᵢⱼ+C²ᵢₖ, then information server 106 may check if Cⱼₖ<δ, where δ is another small real number. If both the conditions hold, then this is a candidate for three column relation with two columns uncorrelated.

Otherwise, C²ᵢⱼ+C²ᵢₖ>1+C²ᵢⱼ+C²ᵢₖ, information server 106 may check if Cⱼₖ>δ, then this is a candidate of three column relation with correlated columns. Accordingly, let the ith, jth and kth columns be xᵢ, xⱼ and xₖ, respectively, then m₁*xᵢ+m₂*xⱼ+m₃* xₖ=K, for some m₁, m₂, m₃ and K, where all of these are some real constants. Again, as noted above, this may be called exact relations since the value of K is a constant (as opposed to belonging to an interval).

Information server 106 may obtain the value of the constants by taking three rows from the sample and substituting the values of xᵢ, xⱼ and xₖ, and taking m₁=1, to obtain the values of m₂, m₃ and K. Every time information server 106 discovers such a relationship, it may remove one of the database columns from the C matrices (i.e., by removing the ith row and ith column of the C matrix). This is to ensure that information server 106 gets the smallest set of relations which are independent of each other.

Information server 106 may also proceed with seeking two column approximate relations. In particular, information server 106 may scan the C matrix computed as above and look for cᵢⱼ>δ. Again, information server 106 may only need to look at the upper triangle part of the matrix excluding the diagonal as explained earlier. If this relation holds, the column pair is a candidate two column approximate relation. Hence, the relation would be of the form m₁*xᵢ+m₂*xⱼ=k, for some m₁, m₂ and k, where m₁ and m₂ are real constants and k belongs to an interval I=[Iₘᵢₙ, Iₘₐₓ].

To find the values of the constant, information server 106 use the following equation. Set m₁=1 and then the value of m2 is given by:

m₂=−W/B={((Tₓ*T_{y})/N)−P}/(σy−T²ₓ/N)

Alternatively, information server 106 may attempt to be more precise and attempt to find the value of m₂ using least square fit of the sample points on the regression line. Finally, to find the interval I, information server 106 may compute the minimum and maximum values of m₁*xᵢ+m₂*xⱼ with the obtained m₁, and m₂. Thus, information server 106 may identify these as interval boundaries.

Information server 106 may also find two column ordering relations. In particular, information server 106 may scan the C matrix computed as above and look for cᵢⱼ>δ. As noted, information server 106 may only need to look at the upper triangle part of the matrix excluding the diagonal as explained earlier. If this relation holds, the column pair is a candidate for ordering relation.

Information server 106 may then compute the minimum and maximum value of Xᵢ−Xⱼ for the columns in question. If both the minimum and. maximum have the same sign (positive or negative), then there exists an ordering relation between the two columns. If the sign is positive then the relation is Xᵢ>Xⱼ and if the sign is negative, then the relation is Xᵢ<Xⱼ.

Information server 106 may find if a third column influences the relation between two columns. Information server 106 may explore this relationship when an approximate relation between two columns is discovered. For each such relation discovered, information server 106 may attempt to find if the relation is influenced by a third column.

For this, information server 106 may look at all the categorical columns from the, same irreducible relation. For each such categorical column, information server 106 may find all the distinct values. For each such value, information server 106 may then look at the rows in the sample which have this value for the categorical column in the question.

Information server 106 then computes the correlations between the two numerical columns. If the correlation is 1 for all the distinct values of the categorical column, then information server 106 has found the column influencing the relation between the two numerical columns. Otherwise, information server 106 continues its investigation with the next categorical column.

In stage 310, information server 106 may provide the algebraic relationships it has found. For example, information server 106 may provide a web page or list (or other suitable output) to client 102 or administration console 112. The user or administrator is then free to test or sample the validity of the algebraic relationships found by information server 106. Of course, the process may be repeated any number of times with different parameters in order to refine the output of information server 106.

For class 2 relations, information server 106 may perform all the steps noted above for class 1 relation except that information server 106 may compute the statistics on the logs of the values in the columns instead of directly on the values in the columns. However, this implies that the values in the columns are positive since the logarithm of a negative number is not defined.

For example, changing of variables, information server 106 may use

log(X)=P,

log(Y)=Q,

log(Z)=R and

log(K)=W.

Now the relation X*Y=K gets converted by information server 106 into P+Q=W. The relation X·Y·Z=K (where · is * or /) gets converted by information server 106 into P ▪Q▪R=W (where ▪ is + or −).

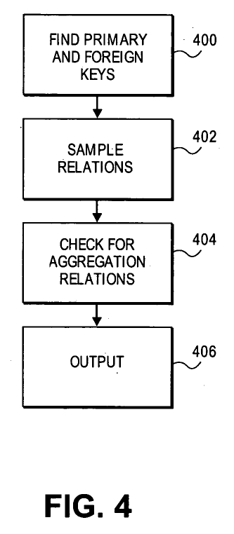

FIG. 4 illustrates an exemplary process for discovering and determining type 3 algebraic relations. In this type, information server 106 may be configured to look for aggregation type of relations. There are two types of aggregation relation that information server 106 may be configured to specifically discover: sum of values in a column; or the number of rows corresponding to one row in the base relation to multiple rows in the other relation.

For purposes of explanation, portions of the relations from the example above are used again in the following.

| OrderNumber | NumItems | Amount |
|---|---|---|
| 1 | 3 | 100.00 |
| 2 | 2 | 50.00 |
| 3 | 1 | 75.00 |

| OrderNumber | OrderItemNumber | Price |
|---|---|---|
| 1 | 1 | 40.00 |
| 1 | 2 | 25.0 |
| 1 | 3 | 35.0 |
| 2 | 1 | 30.0 |
| 2 | 2 | 20.0 |
| 3 | 1 | 75.0 |

As noted, the order relation has a primary key of “OrderItemNumber.” The Order-Number column in the OrderItems table refers to the OrderNumber column in the Orders table. The column NumItems in the Orders table indicates the number of rows in the OrderItems table which refer to this row, and the column OrderAmount holds the sum of Price column of the OrderItems table.

In stage 400, information server 106 finds the appropriate primary key and foreign key (PK-FK) relations in a similar fashion described with reference to FIG. 3. Information server 106 may ignore looking at the primary key from the same table as self joins in this technique are irrelevant. If the containment relation holds, this is a candidate PK-FK relation with one to many mapping. To remove any spurious relations, information server 106 may employ various heuristics. For example, if the ratio of number of rows in the candidate primary key column to the number of distinct values in candidate foreign key column is more than a threshold, information server 106 reject this PK-FK relation as spurious (since this situation may be caused by some indicator type of fields, such as a value 1 in ‘gender’ field may denote ‘male’ and 2 may denote ‘female’).

In stage 402, information server 106 takes samples. For example, information server 106 may take samples from the first relation according to the Bernoulli sampling with a probability p, where p is chosen to ensure sufficient number of samples. Information server 106 may fetch all the rows from the second relation, which refers to one of the sampled rows from the first relation.

In stage 404, information server 106 may check for an aggregation type of algebraic relation. To discover such relations, information server 106 may find the candidate foreign keys by looking for integer or big integer columns that are not unique keys to their respective tables. Information server 106 may then check for containment relation of these columns into the set of primary keys.

Accordingly, information server 106 may create a new table in the following manner. Let the first table be T1 having columns (ignoring the non-numeric and non-key columns) p₁, c₁, c₂, . . . , cₙ, where P₁ is the primary key and cᵢ are the numeric columns. Let the second table be T₂ having columns (ignoring the non-numeric and non-key columns) p₂, f₁, d₁, d2, . . . , dm, where P2 is the primary key, f1 is the foreign key to table T1 and dj are the numeric columns. Information server 106 then creates the new table T₃ with columns p₁, c₁, . . . , cₙ, r, sumD1, sumD2, . . . , sumDm, where r is the number of rows in table T₂, and sumDj is the sum of values in column dj corresponding to the value of P₁ in this row.

Information server 106 then proceeds with calculating the correlation on this table T₃ between columns c₁, c₂, . . . , cₙ and r, sumD1, sumD2, . . . , sumDm. If the correlation between say cᵢ and r is 1, then ci in table T₁ has an aggregation relation of row count type with table T₂. Also, if cⱼ has a correlation with sumDk of 1, then cⱼ in table T₁ has a sum aggregation relation with the column dₖ in table T₂.

In stage 406, information server 106 may provide the algebraic relationships it has found. For example, information server 106 may provide a web page or list (or other suitable output) to client 102 or administration console 112. The user or administrator is then free to test or sample the validity of the algebraic relationships found by information server 106. Of course, the process may be repeated any number of times with different parameters in order to refine the output of information server 106.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of determining an algebraic relationship between columns of two or more relations, said method comprising:
identifying primary keys in the relations;
identifying foreign keys in the relations;
determining irreducible relations from the relations based on the primary and foreign keys;
sampling rows of the irreducible relations;
calculating correlations between columns from the sample rows of the irreducible relations; and
determining algebraic relationships between the columns based on the correlations.

2. The method of claim 1, wherein identifying primary keys in the relations comprises scanning for integer and character fields as candidates for the primary keys.

3. The method of claim 1, wherein identifying foreign keys in the relations comprises scanning for integer and character fields as candidates for the foreign keys.

4. The method of claim 1, wherein identifying foreign keys in the relations comprises scanning for a containment relation.

5. The method of claim 1, wherein determining irreducible relations comprises merging the relations via the primary keys.

6. The method of claim 1, wherein determining irreducible relations comprises dropping columns that are non-numeric or categorical.

7. The method of claim 1, wherein determining algebraic relationships between the columns comprises determining two column exact relations based on scanning a matrix of the correlations.

8. The method of claim 1, wherein determining algebraic relationships between the columns comprises determining three column exact relations based on scanning a matrix of the correlations.

9. The method of claim 1, wherein determining algebraic relationships between the columns comprises determining two column approximate relations based on scanning a matrix of the correlations.

10. The method of claim 1, wherein determining algebraic relationships between the columns comprises determining two column ordering relations based on scanning a matrix of the correlations.

11. The method of claim 1, wherein determining algebraic relationships between the columns comprises determining whether a third column influences the relation between two other columns based on scanning a matrix of the correlations.

12. The method of claim 11, wherein determining whether the third column influences the relation between two numeric columns based on scanning a matrix of the correlations comprises:
scanning the categorical columns of the irreducible relations;
identifying distinct values in each categorical column;
scanning, for each row in the sample of rows from the irreducible relations, values in the numeric columns; and
calculating correlations between the two numeric columns; and
determining an influence of the third column based on the correlations between the numeric columns.

13. An apparatus comprising means configured to perform the method of claim 1.

14. A computer readable medium comprising executable instructions for performing the method of claim 1.

15. A method of determining an algebraic relationship between columns of two or more relations, said method comprising:
identifying primary keys in the relations;
identifying foreign keys in the relations;
determining irreducible relations from the relations based on the primary and foreign keys;
sampling rows of the irreducible relations; and
determining aggregation relations between the relations based on the sampled rows of the irreducible relations.

16. The method of claim 15, wherein determining the aggregation relations between the relations comprises:
creating an additional relation based on the primary keys and summing columns of the two or more relations; and
calculating correlations between columns of the additional relation.

17. The method of claim 15, wherein determining the aggregation relations between the relations comprises:
creating an additional relation based on the primary keys and summing columns of the two or more relations and dropping non-numeric and non-key columns of the two or more relations; and
calculating correlations between numeric columns of the additional relation.

18. An apparatus comprising means configured to perform the method of claim 15.

19. A computer readable medium comprising executable instructions for performing the method of claim 15.

20. A server configured to determine relationships between columns of two or more relations, said server comprising:
a processor; and
a memory, coupled to the processor, that stores executable program code for identifying primary keys in the relations, identifying foreign keys in the relations, determining irreducible relations from the relations based on the primary and foreign keys, sampling rows of the irreducible relations, calculating correlations between columns from the sample rows of the irreducible relations, and determining at least one of algebraic relationships and aggregation relationships between the columns based on the correlations.
